(19) United States
(12) Patent Application Publication
(10) Pub. No.: US 2026/0035189 A1
(43) Pub. Date: Feb. 5, 2026

(54) FOOD PORTIONING DEVICE AND PROGRAM

(71) Applicant: TechMagic, Inc., Tokyo (JP)

(72) Inventors: Ryosuke TAJIMA, Tokyo (JP); Hiroki SONE, Tokyo (JP)

(73) Assignee: TechMagic, Inc., Tokyo (JP)

(21) Appl. No.: 18/847,813

(22) PCT Filed: Mar. 17, 2023
(86) PCT No.: PCT/JP2023/010721

§ 371 Date: Apr. 2, 2025

(30) Foreign Application Priority Data
Mar. 18, 2022 (JP) 2022-043928

(51) Int. Cl. B65G 47/90

(52) U.S. Cl. CPC B65G 47/905; B65G 2201/0202; B65G 2203/041; B65G 2203/042

(57) ABSTRACT

A food portioning device 1 includes a gripper 11 configured to grip a portion of food 21 having an indefinite shape, decision units ((313, 314)) configured to decide a first target value of a weight of the food to be portioned by one gripping operation, which is calculated based on a final target value to be portioned, and to decide a first picking position corresponding to the first target value based on a captured image, and a control unit configured to execute portioning of the food 21 by moving the gripper 11 to the first picking position. When a weight of the food portioned by the one gripping operation by the gripper 11 satisfies the first target value, the decision unit decides a second target value of a weight of the food to be portioned by a next gripping operation and decides a second picking position corresponding to the second target value.

### TECHNICAL FIELD

The present invention relates to a food portioning device and a program therefor.

### BACKGROUND ART

To improve work and service efficiency in a restaurant or the like, there is a demand for automating work for portioning and dishing up food. For example, Non-Patent Document 1 discloses use of a gripper to pick up a target weight of salad or herbs from a container.

### CITATION LIST

### Patent Document

Non-Patent Document 1: Prabhakar Ray and Matthew J. Howard, “Robotic Untangling of Herbs and Salads with Parallel Grippers,” in 2020 IEEE/RSJ International Conference on Intelligent Robots and Systems (IROS), Oct. 25-29, 2020, Las Vegas, NV, USA (Virtual).

### SUMMARY OF THE INVENTION

### Problems to be Solved by the Invention

Non-Patent Document 1 describes adjusting a depth by which a gripper is inserted into a container containing food and a gripping mechanism (for adjusting a width of an opening, or the like) of the gripper, to grip food of a pre-set target weight from [a tray in the container] the container or the like in which the food is provided, and divide the food into portions. However, even in a case where an area or volume of a gripping mechanism can be adjusted, it is difficult to accurately grip (to portion) a target weight of the food when a density of the food is uneven or voids are present in the food. An object of the present invention is to accurately portion food of a target weight.

### Means for Solving the Problems

In one aspect, the present invention provides a food portioning device that includes a gripper configured to grip a portion of food having an indefinite shape, a moving mechanism configured to move the gripper, a weighing unit configured to measure a weight of the food gripped by the gripper, an imaging unit configured to image a surface shape of the food, a decision unit configured to decide a first target value of a weight of the food to be portioned by one gripping operation, the first target value calculated based on a final target value, and to decide a first picking position corresponding to the first target value based on an image captured by the imaging unit, and a control unit configured to execute portioning of the food by moving the gripper to the first picking position by the moving mechanism, such that when a weight of the food portioned by the one gripping operation by the gripper satisfies the first target value, the decision unit decides a second target value of a weight of the food to be portioned by a next one gripping operation, and decides a second picking position corresponding to the second target value, and the control unit executes portioning of the food by moving the gripper to the second picking position, and in a case that the weight of the food portioned by the one gripping operation by the gripper does not satisfy the first target value, the decision unit re-decides the first target value, and the control unit executes gripping of the food at the re-decided first target value.

Thus, according to the present invention, it is possible to accurately portion a target weight of food.

In a preferred aspect, a distal end of the gripper is tapered in a direction toward which where the food is gripped.

According to the present aspect, the smaller a target value of a weight of the food to be gripped, the smaller an error amount can be of the target value of the weight of the food to be gripped.

In a preferred aspect, a shape of the gripper is changed in accordance with the first target value and the second target value.

According to the present aspect, the smaller the target value of the weight of the food to be gripped, the smaller the error amount can be of the target value of the weight of the food to be gripped.

In a preferred aspect, the decision unit decides, for each food, a frequency of a gripping operation to be executed and a target value of a weight of the food to be portioned by each gripping operation.

According to the present aspect, a condition of the gripping operation can be changed in accordance with characteristics (a viscosity, a density, or the like) of the food to be portioned.

In a preferred aspect, the decision unit generates a learning model that learns, for each food, measurement data of a weight of the food gripped by the gripping part at a picking position and image data of the picking position, and the first picking position and the second picking position are decided using the learning model.

According to the present aspect, the picking position can be appropriately decided according to the target value of the weight of the food to be gripped.

In a preferred aspect, a density of the food is uneven, and the decision unit decides the first picking position and the second picking position further based on a density calculated based on the captured image.

According to the present aspect, the picking position is decided based on an unevenness of the density of the food.

In addition, in another aspect, the present invention provides a program that causes a computer to function as a decision unit configured to decide a first target value of a weight of food to be portioned by one gripping operation, the first target value calculated based on a final target value of a portioning amount when portioning a portion of the food having an indefinite shape, and, based on a captured image, decide a first picking position corresponding to the first target value, and a control unit configured to execute portioning of the food by moving to the first picking position a gripping part that grips a portion of the food, and when a weight of the food portioned by the one gripping operation by the gripping part satisfies the first target value, the decision unit decides a second target value of a weight of the food to be portioned by the next one gripping operation, and decides a second picking position corresponding to the second target value, and the control unit executes portioning of the food by moving the gripping part to the second picking position, and if the weight of the food portioned by the one gripping operation by the gripping part does not satisfy the first target value, the decision unit re-decides the first target value, and the control unit executes gripping of the food at the re-decided first target value.

### BRIEF DESCRIPTION OF THE DRAWINGS

FIG. 1 is a diagram illustrating a configuration of a food portioning device according to an embodiment.

FIG. 2 is a block diagram illustrating a hardware configuration of the food portioning device according to the embodiment.

FIG. 3 is a block diagram illustrating a functional configuration of the food portioning device according to the embodiment.

FIGS. 4A to 4C are diagram illustrating a configuration of a gripper of the food portioning device according to the embodiment.

FIGS. 5A and 5B are diagrams describing gripping of food by the gripper of the food portioning device according to the embodiment.

FIG. 6 is a diagram describing the gripping of the food by the gripper of the food portioning device according to the embodiment.

FIG. 7 is a diagram illustrating a configuration of a rotation mechanism of the food portioning device according to the embodiment.

FIGS. 8A to 8C are diagrams describing rotation control of the gripper of the food portioning device according to the embodiment.

FIG. 9 is a flowchart illustrating processing by the food portioning device according to the embodiment.

FIG. 10 is a flowchart illustrating picking control of the food portioning device according to the embodiment.

FIGS. 11A and 11B are diagrams describing the gripping of the food by a gripper of a food portioning device according to an example modification.

FIGS. 12A and 12B are diagrams describing a container according to the example modification.

### MODE FOR CARRYING OUT THE INVENTION

### Embodiment

Hereinafter, a food portioning device according to an embodiment of the present invention will be described. In the drawings and the following description, a right-left direction is defined as an X-axis direction, a front-rear direction is defined as a Y-axis direction, an up-down direction is defined as a Z-axis direction, directions or sides indicated by arrows X, Y, and Z are defined as rightward, rearward, and upward, or a right side, a rear side, and an upper side, respectively, and opposite directions or opposite sides thereof are defined as leftward, frontward, or downward, or a left side, a front side, or a lower side, respectively. In addition, in the drawings, a case where “.” is shown in “o” means an arrow in a direction from the back to the front of the page, and a case where “x” is shown in “o” means an arrow in a direction from the front to the back of the page.

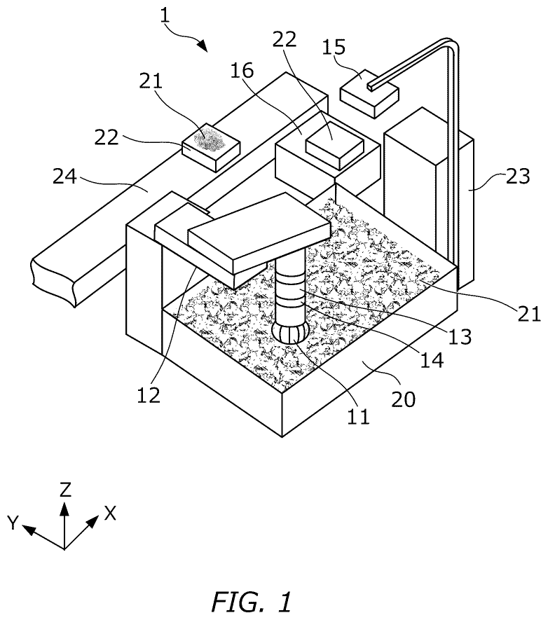

FIG. 1 is a diagram illustrating a configuration of a food portioning device 1 according to an embodiment. The food portioning device 1 includes a gripper 11, a robot arm 12, a rotation mechanism 13, a weight meter 14, an imaging device 15, and a platform scale 16.

The gripper 11 is provided at a distal part of the robot arm 12, is moved by operation of the robot arm 12, and can grip a portion of food 21 of an indefinite shape provided in a container 20. That is, the gripper 11 is an example of a gripping part that grips a portion of the food 21 having an indefinite shape.

The food having an indefinite shape is generally food that is not recognized as having an inherent shape, or is food that is recognized to have a substantially continuous body, and, in a case of portioning, is managed by weight, not by a number of elements that constitute the food. Examples include high-viscosity kneaded salads such as potato salad, macaroni salad, and spaghetti salad, julienned cabbage, simmered hijiki, or the like.

The robot arm 12 moves the gripper 11 attached to the distal end part of the robot arm 12 and moves the gripper 11 to a position at which the gripper 11 can grip a portion of the food 21. In addition, in a state where the gripper 11 grips a portion of the food 21, the gripper 11 is moved to a position of the platform scale 16 on which a container 22, to be described later, is disposed. The robot arm 12 can move the gripper 11 in any of the X-axis direction, the Y-axis direction, and the Z-axis direction. The robot arm 12 is an example of a moving mechanism that moves the gripper 11, namely gripping parts.

The rotation mechanism 13 is a mechanism that is provided between the distal end portion of the robot arm 12 and the gripper 11 and rotates the gripper 11 about a rotation axis along the Z-axis direction (up-down direction). The rotation mechanism 13 is an example of a rotation mechanism that rotates the gripper 11, namely the gripping parts.

The weight meter 14 is provided above the gripper 11 and measures a weight of the gripper 11. A weight of the gripper 11 increases when the gripper 11 grips the food 21. Thus, a weight of the food 21 that is gripped by the gripper 11 can be measured by detecting the increase in weight of the gripper 11. The weight meter 14 is an example of a weighing unit that measures the weight of the food held by the gripper 11, namely the gripping parts.

The imaging device 15 is a camera that is installed above the container 20 and captures an image showing a surface shape of the food in the container 20 from above. The imaging device 15 has a function of measuring a distance to the target object to be imaged, and can measure a height of (each portion of) the food in the container 20 in the Z-axis direction. The imaging device 15 is an example of an imaging unit that images a surface shape of the food.

The platform scale 16 is installed outside the container 20, and a container into which the food 21 is portioned is placed on an upper area of the platform scale 16. The platform scale 16 measures the weight of the food 21 gripped by the gripper 11 and portioned into the container 22.

The container 20 is a box having an upper opening, and side surfaces that comprise walls extending upward at four sides of a rectangular bottom surface of the box. The food 21 is provided within the container 20. In the present embodiment, the food 21 is described as food having a high viscosity and an indefinite shape, such as potato salad, but the present invention is not limited thereto.

A container supply machine 23 is installed outside the container 20 and adjacent to the platform scale 16. A plurality of containers 22 are stored in the container supply machine 23, and the containers 22 are removed one at a time for transport onto the platform scale 16. When the portioning of the food 21 into the container 22 on the platform scale 16 ends, the container 22 is moved from the platform scale 16 onto a transport machine 24.

The transport machine 24 is installed outside the container 20 at a position on a side opposite to the container supply machine 23 with respect to the platform scale 16. The transport machine 24 is configured to be equipped with a conveyor belt or the like. The container 22 into which the food 21 has been portioned is moved from the platform scale 16 onto the conveyor belt and transported.

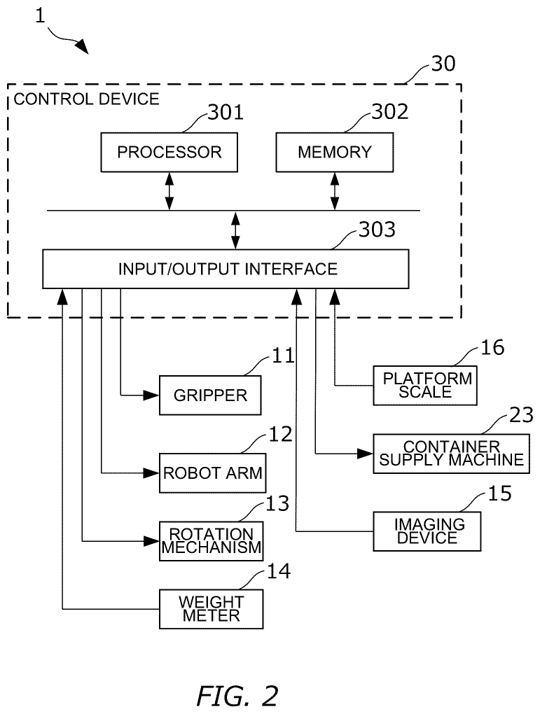

FIG. 2 is a block diagram illustrating a hardware configuration of the food portioning device 1. The food portioning device 1 acquires information from the weight meter 14, the imaging device 15, and the platform scale 16, and includes a control device 30 to control the operation of the gripper 11, the robot arm 12, the rotation mechanism 13, and the container supply machine 23. A position at which the control device 30 is installed is not particularly limited, but for example, may be installed adjacent to the robot arm 12.

The control device 30 is a computer including a processor 301, a memory 302, and an input/output interface 303. These elements are connected to each other to be able to communicate, for example, by a bus.

The processor 301 controls each portion of the food portioning device 1 by reading out and executing a computer program (hereinafter, simply referred to as a program) stored in the memory 302. The processor 301 is, for example, a central processing unit (CPU). The memory 302 is a storage device that stores an operating system, and various programs, data, or the like read by the processor 301.

The memory 302 includes a main storage device and an auxiliary storage device. The main storage device includes, for example, a random access memory (RAM) and a read only memory (ROM). The auxiliary storage device includes a solid state drive or a hard disk drive. The input/output interface 303 relays signals between the processor 301 and the gripper 11, the robot arm 12, the rotation mechanism 13, the weight meter 14, the imaging device 15, the platform scale 16, and the container supply machine 23.

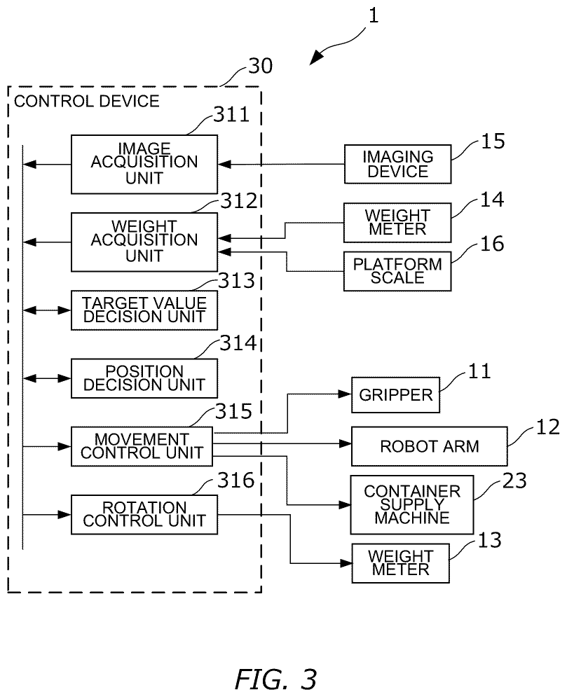

FIG. 3 is a block diagram illustrating a functional configuration of the food portioning device 1. The control device 30 of the food portioning device 1 functions as an image acquisition unit 311, a weight acquisition unit 312, a target value decision unit 313, a position decision unit 314, a movement control unit 315, and a rotation control unit 316 by the processor 301 reading and executing a program stored in the memory 302. The target value decision unit 313 and the position decision unit 314 are examples of a decision unit. The movement control unit 315 and the rotation control unit 316 are each an example of a control unit.

The image acquisition unit 311 acquires image data indicating an image of the surface shape of the food 21 imaged by the imaging device 15 and distance data indicating a distance to the surface of the food 21. Then, height data indicating a height of each portion of the surface of the food 21 is calculated from the distance data.

The weight acquisition unit 312 acquires weight data indicating the weight of the food 21 gripped by the gripper 11, which is measured by the weight meter 14. In addition, the weight acquisition unit 312 acquires weight data indicating the weight of the food 21 portioned into the container 22, which is measured by the platform scale 16.

The target value decision unit 313 decides a target value of the weight of the food 21 to be gripped by the gripper 11. Target values are decided as a final target value, a first target value, and a second target value (in some cases, a third target value).

The final target value is a weight of the food 21 to be portioned into the container 22. In the present embodiment, the gripping operation of the food 21 by the gripper 11 can be performed a plurality of times so as to portion the food 21 with a weight of the final target value into the container 22.

The first target value is a target value of the weight of the food 21 acquired by a first gripping operation by the gripper 11, and is a value equal to or smaller than the final target value. The second target value is a target value of the weight of the food 21 acquired by a second gripping operation by the gripper 11. The second target value is a value obtained by subtracting the weight of the food 21 actually gripped and portioned into the container 22 by the first gripping from the final target value.

In a case where the total weight of the food 21 acquired by the first and second gripping operations does not reach the final target value, the target value decision unit 313 decides a third target value, after which a third gripping operation is performed.

The position decision unit 314 decides a picking position, which is a position at which the food 21 having the weight decided by the target value decision unit 313 can be held by the gripper 11, based on the image data and the height data acquired by the image acquisition unit 311. A plurality of positions are selected as candidates for the picking position, and one of the plurality of positions is decided. The picking position is indicated by the coordinate value of each of the X-axis direction, the Y-axis direction, and the Z-axis direction of a predetermined portion (for example, a distal end part) of the gripper 11.

The movement control unit 315 moves the gripper 11 to the picking position decided by the position decision unit 314 by driving and controlling the robot arm 12. Next, the movement control unit 315 controls the gripper 11 to hold and grip a portion of the food 21, and moves the gripper 11 to the position above the platform scale 16 in a gripped state. Then, the movement control unit 315 controls the gripper 11 to cause the food 21 being gripped to fall into the container 22 disposed on the platform scale 16.

The rotation control unit 316 performs control of rotating the gripper 11 about the center line of the gripper 11 as a rotation axis along the Z-axis direction of the gripper 11 at the position at a point in time when the gripper 11 ends the operation of gripping the food 21 at the picking position under the control of the movement control unit 315.

During the execution of the rotation control by the rotation control unit 316, the movement control unit 315 performs control of moving the rotation axis in a direction along an XY plane (a plane including the X-axis and the Y-axis) by driving and controlling the robot arm 12. That is, the gripper 11 is moved along the XY plane while being rotated.

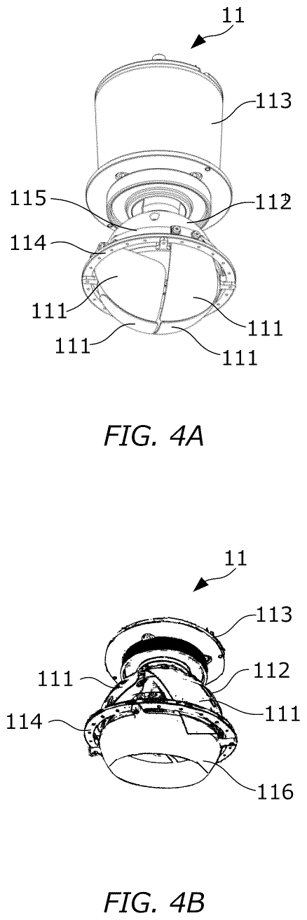

FIG. 4 is a diagram illustrating the configuration of the gripper 11. FIG. 4A is an external view illustrating a state where gripper claws 111, which comprise a gripping member of the distal end of the gripper 11, are closed, FIG. 4B is an external view illustrating a state where the gripper claws 111 of the distal end of the gripper 11 are opened, and FIG. 4C is a cross-sectional view illustrating an internal structure of the gripper 11.

The gripper 11 is configured to have four gripper claws 111, a connecting part 112, and a base body 113. The four gripper claws 111 for gripping the food 21 are provided at the downward distal end part of the gripper 11. Each of the gripper claws 111 has a shape obtained by equally dividing a hemisphere (or a portion of a sphere) into four portions, and as illustrated in FIG. 4A, in a state where the four gripper claws 111 are closed, a hemispherical shape is formed by the four gripper claws 111.

In the state illustrated in FIG. 4A (hereinafter, referred to as a closed state), the food 21 within the hemispherical shape formed by the four gripper claws 111 can be gripped. In the present embodiment, the gripper claws 111 are provided as four parts, but may be provided as a plurality of parts other than four in a shape obtained by dividing the hemispherical shape into an equivalent plurality of portions.

FIG. 4B illustrates a state where the four gripper claws 111 are moved upward and the hemispherical shape is opened (hereinafter, referred to as an open state). The open state is a state where the picking position is subject to movement and the food 21 positioned immediately below has not been gripped. When the open state transitions to the closed state shown in FIG. 4A, the food 21 positioned immediately below is gripped. In addition, in the closed state shown in FIG. 4A the food 21 gripped by the gripper claws 111 is allowed to fall downward by transitioning of the gripper claws 111 to the open state shown in FIG. 4B. In a case where the gripper claws 111 are in the open state, an internal wiping member 116 is exposed as illustrated in FIG. 4B.

When the closed state in which the gripper claws 111 grip the food 21 transitions to the open state, the outer peripheral part of the internal wiping member 116 provided inside the gripper claws 111 rubs against the inner surface of the gripper claws 111, so that the food 21 adhering to the inner surface of the gripper claws 111 can be peeled off and fall.

In FIG. 4C, a connecting part 112 is provided on an upper side of the gripper claws 111 and the internal wiping member 116, and a base body 113 is provided on an upper side of the connecting part 112. A sweeping f member 117 is provided on an inner side of the internal wiping member 116, and the internal wiping member 116 is fixed to the sweeping member 117. The connecting part 112 has a connecting gear 1121, a rotation axis 1122, and a support member 1123, and the base body 113 is provided with a motor 1131.

One end of the rotation axis 1122 is connected to the motor 1131, and the other end is connected to the sweeping member 117. Thus, the sweeping member 117 is rotated together with the rotation axis 1122 by rotation of the motor 1131, and the internal wiping member 116 fixed to the sweeping member 117 is also rotated. By the rotation operation, the food 21 adhering to the inner surface of the gripper claws 111 is peeled off and falls, and the food 21 adhering to the internal wiping member 116 can be swept off.

A pinion gear is provided on the rotation axis 1122 and meshes with the connecting gear 1121. The connecting gear 1121 has an arc shape, and although only one gear is illustrated in FIG. 4C, four such gears are provided. The four connecting gears 1121 are connected to the four support members 1123, respectively. Further, the four support members 1123 are connected to the four gripper claws 111 and support the gripper claws 111.

FIG. 4C illustrates a state where the gripper claws 111 are in the closed state, as in FIG. 4A. In this state, the connecting gear 1121 is meshed with the pinion gear of the rotatable shaft 1122 at an upper side position. In this state, the rotatable shaft 1122 is rotated by the rotation of the motor 1131. By the rotation of the rotatable shaft 1122, the connecting gear 1121 that is meshed with the pinion gear provided on the rotatable shaft 1122 moves along the arc shape, and a lower part of the connecting gear 1121 in FIG. 4C moves upward, i.e., in a direction toward a position in which the lower part is meshed with the rotatable shaft 1122.

By the movement of the connecting gear 1121, the support member 1123 also moves upward, and the gripper claws 111 connected to the support member 1123 move upward. As a result, the gripper claws 111 transition to the open state illustrated in FIG. 4B.

In the open state of the gripper claws 111, by rotating the motor 1131 in a reverse direction, the connecting gear 1121 can be moved to the position illustrated in FIG. 4C, and the gripper claws 111 can be set to the closed state.

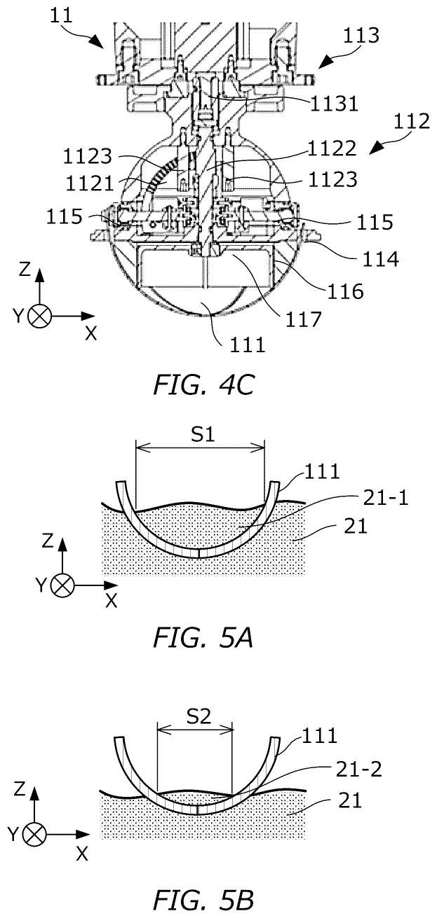

FIG. 5 is a diagram describing the gripping of the food 21 by the gripper claws 111 of the gripper 11. FIG. 5A is a diagram illustrating a case where a relatively large amount of food 21-1 is gripped, and FIG. 5B is a diagram illustrating a case where a relatively small amount of food 21-2 is gripped.

As illustrated in FIG. 5A, in a case where a large amount of the food 21-1 is to be gripped, the gripper claws 111 are moved to a position lower than the surface position of the food 21 in the Z-axis direction to bring the gripper claws 111 into the closed state. In this case, since the distal end parts of the gripper claws 111 reach a deep position of the food 21, it is possible to grip a larger amount of the food 21-1 with the gripper claws 111.

As illustrated in FIG. 5B, in a case where the small amount of the food 21-2 is to be gripped, the gripper claws 111 are moved to an upward position with respect to the surface position of the food 21 in the Z-axis direction as compared with the case shown in FIG. 5A, and the gripper claws 111 are brought into the closed state. In this case, since the distal end parts of the gripper claws 111 only reach a shallow position of the food 21 as compared with the case shown in FIG. 5A, the small amount of the food 21-2 can be gripped with the gripper claws 111.

An area S1, which is a range of the food 21 that can be gripped by the gripper claws 111 in FIG. 5A, is larger than an area S2, which is a range of the food 21 that can be gripped by the gripper claws 111 in FIG. 5B. The areas S1 and S2 are illustrated as widths in FIG. 5, but are actually ranges illustrated as areas also extending rearward in the Y-axis direction.

In the present embodiment, as described above, it is assumed that the food 21 is gripped by the gripper 11 a plurality of times to portion the food 21 with the weight of the final target value. The operation of gripping the relatively large amount of the food 21-1 as illustrated in FIG. 5A is performed in a case of the first gripping. Then, the operation of gripping the relatively small amount of the food 21-2 as illustrated in FIG. 5B is performed in the second and subsequent gripping.

As illustrated in FIG. 5A, in a case where the range of the relatively large area S1 on the surface of the food 21 is gripped, an error in the weight of the gripped food 21-1 with respect to the target value increases as compared with the case where the range of the relatively small area S2 as illustrated in FIG. 5B is gripped.

This is because the surface of the food 21 is easily affected by unevenness.

For example, when the target value in a case of performing the gripping as illustrated in FIG. 5A is 50 g, the actual gripped weight is about 45 g to 55 g, and the range of the error is +5 g. Then, for example, when the target value in a case of performing the gripping as illustrated in FIG. 5B is 10 g, the actual gripped weight is about 9 g to 11 g, and the range of the error is +1 g, which is smaller than +5 g in the case of FIG. 5A.

Therefore, in the first gripping operation, a relatively large amount of the food 21-1 as illustrated in FIG. 5A is gripped to acquire a weight close to the final target value, and a remaining small amount of the food 21-2 for reaching the final target value is gripped in the second and subsequent gripping operations. The error in the gripped weight with respect to the target value in the second and subsequent gripping operations can be reduced, and the food 21 having the weight of the final target value can be reliably acquired by the second or third (or in some cases, a frequency equal to or greater than those) gripping operations.

As described above, the distal ends of the gripper claws 111 of the gripper 11 according to the present embodiment has a tapered shape in the closed state. Therefore, the smaller the amount of food 21 to be gripped, the smaller the error can be of the gripped weight with respect to the target value.

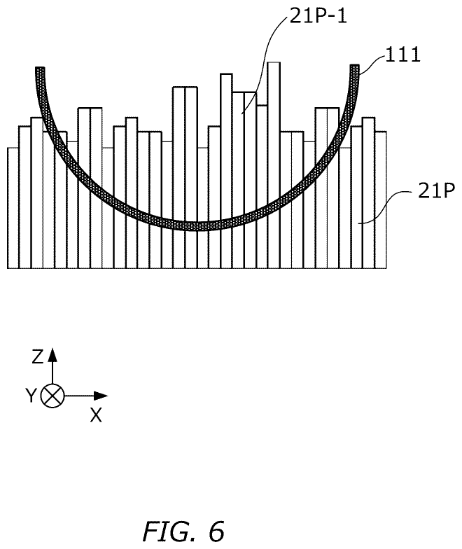

FIG. 6 is a diagram describing the gripping of the food 21 by the gripper claws 111 of the gripper 11. In FIG. 6, a food 21P is illustrated as a graph of the height position (Z-axis direction position) of the surface for each predetermined range in the X-axis direction. Although FIG. 6 illustrates a cross section along the X-axis direction, the food 21P can be represented by a graph that also extends in the Y-axis direction.

As illustrated in FIG. 6, a graph illustrating the height direction position of the food 21P can be generated by the image acquisition unit 311 of the control device 30 acquiring image data indicating the image of the surface shape of the food 21 and height data indicating the height of each portion of the surface of the food 21 from the imaging device 15.

The position decision unit 314 of the control device 30 generates a graph (the food 21P) indicating the height at each position of the food 21 in the X-axis direction (and the Y-axis direction) as illustrated in FIG. 6 based on the image data and the height data acquired by the image acquisition unit 311.

The position decision unit 314 selects the position at which the food 21 having the weight that is the target value decided by the target value decision unit 313 can be gripped, based on the graph. In the control device 30, average density data of the food 21 is preset, and the position decision unit 314 calculates the volume of the food P to be gripped based on the weight, which is a target value, and the set density data.

The position decision unit 314 selects the position (an X-axis coordinate, a Y-axis coordinate, and a Z-axis coordinate) of the gripper claws 111 at which the food 21 having a volume corresponding to the weight of the target value can be gripped, from the shape of the gripper claws 111 in the closed state, the height data of each portion of the food 21P, and the set density data.

As illustrated in FIG. 6, the volume of the food 21P-1 to be gripped by the gripper claws 111 is decided by the shape (known) of the gripper claws 111, the positions of the gripper claws 111 in each of the X-axis direction, the Y-axis direction, and the Z-axis direction, the surface shape (height distribution) of the food 21P, and the density (preset) of the food 21P.

The position decision unit 314 decides the plurality of gripping positions (picking positions) by calculating the gripping positions in the Z-axis direction at which the food 21 having a desired volume can be gripped at the plurality of positions in the XY plane in which it is predicted that a volume corresponding to the weight of the target value can be gripped.

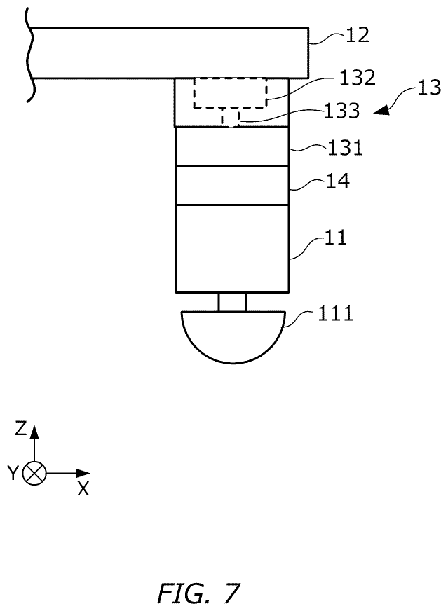

FIG. 7 is a diagram illustrating a configuration of the rotation mechanism 13 of the food portioning device 1. As illustrated in FIG. 7, the distal end part of the robot arm 12 is provided with the gripper 11, the rotation mechanism 13, and the weight meter 14. The rotation mechanism 13 includes a connecting part 131, a motor 132, and a motor driven rotation shaft 133.

The connecting part 131 is provided below the rotation mechanism 13 and connects the gripper 11, the weight meter 14, and the rotation mechanism 13. The gripper 11 is attached to the weight meter 14, and the weight meter 14 is attached and fixed to the connecting part 131.

The motor driven rotation shaft 133 is rotated by the motor 132. The motor 132 is fixed to the robot arm 12. The motor rotation axis 133 is fixed to the connecting part 131, and each of the connecting part 131, the weight meter 14, and the gripper 11 are integrally rotated under rotation of the motor driven rotation shaft 133. The motor driven rotation shaft 133 is arranged at a center line L of the gripper 11 (and the gripper claws 111). The gripper 11 (and the gripper claws 111) has a symmetrical shape relative to the center line L under rotation of the motor driven rotation shaft 133, and rotates about the center line L, which acts as an axis of rotation. Hereinafter, the center line L is also referred to as the gripper rotation axis L.

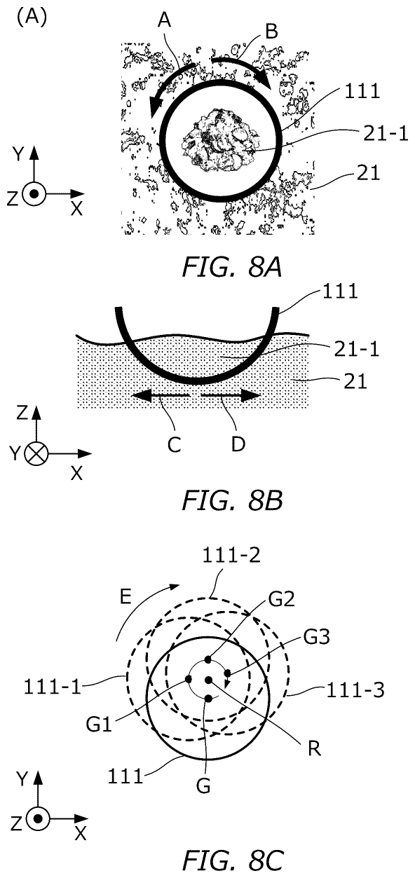

FIG. 8 is a diagram describing the rotation control of the gripper claws 111 of the gripper 11. FIG. 8B is a plan view describing the rotation control of the gripper claws 111 in a state where the gripper claws 111 grip the food 21-1. FIGS. 8B and 8C are cross-sectional view and a plan view, respectively, illustrating a control example of changing the position of the axis of rotation L (that is, the gripper rotation axis L) of the gripper claws 111 in a state where the gripper claws 111 grip the food 21-1.

FIG. 8B illustrates a state where the gripper claws 111 of the gripper 11 are inserted into the picking position of the food 21 and the gripper claws 111 are set in a closed state to grip the food 21-1. In this state, the rotation control unit 316 of the control device 30 executes the control of rotating the gripper 11. By rotating the gripper 11, the gripper claws 111 also rotate in the same manner.

The rotation of the gripper 11 is performed centered on the gripper rotation axis L. The outer shape of the gripper claws 111 in the closed state is a shape that is symmetrical relative to the gripper rotation axis L. It is preferable that the entire gripper 11 has a shape that is symmetrical relative to the center line L.

The rotation control unit 316 controls rotation in an arrow A direction shown in FIG. 8B (hereinafter, referred to as a forward rotation direction) and then controls rotation in an arrow B direction (hereinafter, referred to as a reverse rotation direction). It is preferable that each of the rotation angles in the forward rotation direction and the reverse rotation direction are within a range of 45 degrees to 135 degrees.

The arrow B direction may be the forward rotation direction and the arrow A direction may be the reverse rotation direction. That is, the rotation may be performed in the arrow A direction after the rotation in the arrow B direction. The rotation control as described above is performed by the rotation control unit 316 controlling the rotation mechanism 13.

As illustrated in FIG. 8B, in a state where the rotation control unit 316 performs the rotation control of the gripper 11, that is, during the rotation of the gripper 11 and the gripper claws 111, the movement control unit 315 moves the gripper 11 in the arrow C direction in a plane (for example, in the XY plane or the horizontal plane orthogonal to the rotation axis) intersecting the gripper rotation axis L, or in an arrow D direction that is the reverse direction of the arrow C direction by driving and controlling the robot arm 12. That is, the rotation control of the gripper 11 is performed while changing the position of the gripper rotation axis L (or the motor driven rotation shaft 133) in the first direction (the arrow C direction) or the second direction (the arrow D direction).

For example, while the gripper claws 111 rotate in the forward direction, the gripper rotation axis L may move in the arrow C direction, and while the gripper claws 111 rotate in the reverse direction, the gripper rotation axis L may be moved in the arrow D direction, or vice versa. That is, the gripper rotation axis L performs a linear reciprocating motion in the XY plane in conjunction with the direction of rotation.

FIG. 8C illustrates another example of the movement of the position of the gripper rotation axis L (indicated by L1 to L4 in the figure), which is performed during the rotation of the gripper 11 by the rotation control unit 316. In FIG. 8C, the gripper claws 111 are moved such that the gripper rotation axis L defines a circular trajectory in the XY plane centered on a central axis R (axis along the Z-axis direction).

The point L1 and a circle G in FIG. 8C indicate the outer peripheral position of the gripper rotation axis L and the gripper claws 111 at a point in time when the food 21-1 is gripped. The symbols L2, L3, and L4 indicate respective positions on the movement trajectory centered on the central axis R of the gripper rotation axis L. The circles G2, G3, and G4 illustrate the outer peripheral position of the gripper claws 111 of the gripper 11 in a case where the gripper rotation axis L is at the position of each of the L2, L3, and L4.

The gripper rotation axis L moves position in an arrow E direction or in an arrow F direction, which is the opposite direction to the arrow E direction. The movement control of the gripper rotation axis L in FIG. 8C is performed by the movement control unit 315 of the control device 30 that drives and controls the robot arm 12 in the same manner as shown in FIG. 8B.

For example, while the gripper claws 111 rotate in the forward direction, the gripper rotation axis L may move in the arrow E direction, and while the gripper claws 111 rotate in the reverse direction, the gripper rotation axis L may move in the arrow F direction, or vice versa. In FIG. 8C, although the gripper rotation axis L moved in a range of a trajectory close to a complete circular shape (close to 360 degrees), a range of a semicircular shape (a rotation of 180 degrees) may be used, or a range of a ¼ of a circle that is less than 180 degrees (a rotation of 90 degrees) may be used.

As described above, by performing the control of moving the position of the gripper rotation axis L while the gripper 11 is rotated, the outer surface of the gripper claws 111 are pressed against the food 21 in their vicinity. In this manner, the food 21 adhering to the outer surface of the gripper claws 111 is removed from the outer surface of the gripper claws 111 by being rubbed (wiped) on the side of the food 21 in their vicinity.

In addition, as illustrated in FIG. 8B, by rotating the gripper 11 and moving the gripper rotation axis L as illustrated in FIGS. 8B and 8C, the food 21 adhering to any position on the outer peripheral surface of the gripper claws 111 of the gripper 11 can also be uniformly rubbed against the food 21 in their vicinity.

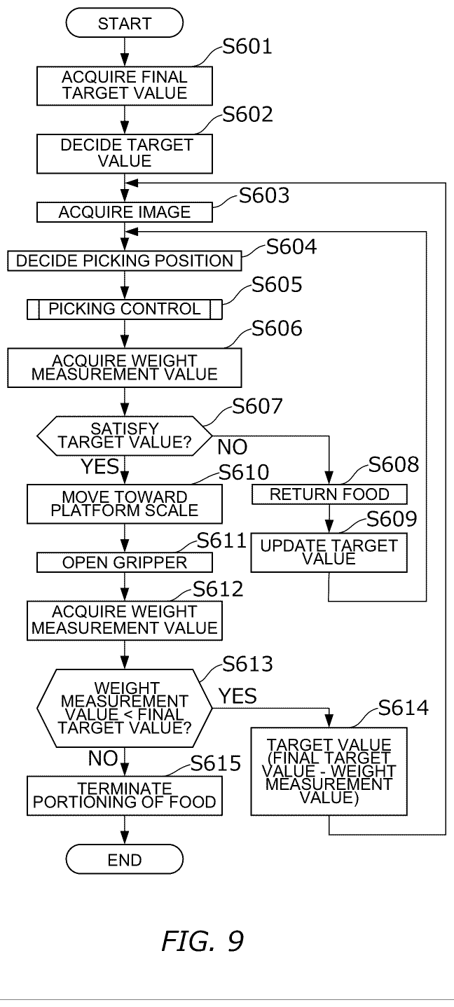

FIG. 9 is a flowchart illustrating processing of the control device 30 of the food portioning device 1. The processor 301 of the control device 30 reads out and executes the program stored in the memory 302, to execute the processing illustrated in FIG. 9.

First, the target value decision unit 313 of the control device 30 acquires the final target value of the weight of the food 21 to be portioned into the container 22 (step S601). The final target value is preset by the user and is stored in the memory 302 of the control device 30.

Subsequently, the target value decision unit 313 decides the first target value that is the target value of the weight of the food 21 to be gripped in the first gripping operation by the gripper 11 (step S602). For example, assuming that the final target value acquired in the step S601 is 75 g. When the error of the final target value is allowed to be up to +3 g, the final target value is 75 to 78 g. The first target value in the first gripping operation is set, for example, in a range of 35 g to 75 g, which is equal to or smaller than the final target value. The reason why the first target value (the lower limit thereof) is provided is so that in a case where the gripped amount is deviates considerably from the final target value (for example, 50% or less of the final target value), if the gripped amount is released and the gripping operation is restarted from the beginning, a time required for the final gripping operation or for the total amount of the portioned food to reach the final target value is likely to be shortened.

Subsequently, the image acquisition unit 311 acquires the image data indicating the surface shape of the food 21 and the height data indicating the height of each portion of the surface from the imaging device 15 (step S603). The position decision unit 314 calculates the volume of the food 21 to be gripped from the weight of the first target value decided by the target value decision unit 313 and the preset density data of the food 21. Since the first target value is 35 g to 75 g as described above, here, the volume of the food 21 to be gripped is calculated with, for example, 60 g as a reference value, which is a value between 35 g and 75 g. Then, the position decision unit 314 decides the plurality of picking positions (the X-axis coordinate, the Y-axis coordinate, and the Z-axis coordinate) of the gripper 11 at which it is predicted that the food 21 having the corresponding volume can be gripped (step S604). Subsequently, the gripping control is executed by the movement control unit 315 and the rotation control unit 316 (step S605).

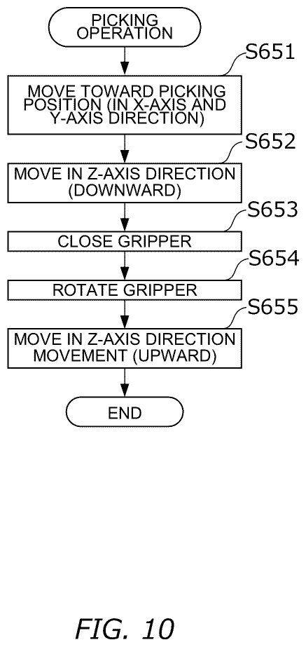

FIG. 10 is a flowchart illustrating the picking control performed by the movement control unit 315 and the rotation control unit 316 of the control device 30. The processor 301 of the control device 30 reads out and executes the program stored in the memory 302, and the processing illustrated in FIG. 10 is executed. Hereinafter, the gripping control illustrated in FIG. 10 will be described.

First, the movement control unit 315 selects one of a plurality of picking positions decided by the position decision unit 314 and moves the gripper 11 to a position of the X coordinate value and the Y coordinate value indicated by the picking position (step S651). The movement is performed by driving and controlling the robot arm 12. During the movement, the gripper claws part 111 of the gripper 11 are set in the open state. The position of the gripper 11 in the Z-axis direction is moved to a sufficiently high position with respect to the height of the surface of the food 21 such that the gripper 11 does not come into contact with the surface of the food 21.

In a case where the movement of the gripper 11 to the position of the X coordinate value and the Y coordinate value indicated by the picking position is completed, the movement control unit 315 drives and controls the robot arm 12 to cause the gripper 11 to be moved downward and moved to the position of the Z-axis coordinate value indicated by the picking position (step S652).

Subsequently, the movement control unit 315 performs control to set the gripper claws 111 of the gripper 11 to the closed state (step S653). The control causes a state where the food 21 is gripped in the closed gripper claws 111. Hereinafter, the gripped food 21 may be referred to as the food 21-1.

Subsequently, the rotation control unit 316 controls rotation of the gripper 11 by driving and controlling the rotation mechanism 13 (step S654). In this case, during the rotation of the gripper 11, the movement control unit 315 performs control (wiping operation) of moving the gripper rotation axis L in the XY plane (horizontal plane) by driving and controlling the robot arm 12. That is, the rotation control illustrated in FIG. 8B is performed, and the movement control of the gripper rotation axis L illustrated in FIG. 8B or FIG. 8C is performed.

Subsequently, the movement control unit 315 causes the gripper 11 to be moved upward by driving and controlling the robot arm 12, and to be moved to a sufficiently high position with respect to the height of the surface of the food 21 (step S655).

Returning to the description with reference to FIG. 9, in a state where the food 21-1 is gripped in the gripper claws 111 of the gripper 11, the weight acquisition unit 312 acquires the weight measurement value of the food 21-1 gripped by the gripper claws 111 from the weight meter 14 (step S606). Then, the weight acquisition unit 312 determines whether or not the acquired weight measurement value satisfies the first target value, that is, whether or not it is within the range of the first target value (35 g to 75 g) (step S607).

When the acquired weight measurement value does not satisfy the first target value (step S607: No), that is, when the gripped weight is too small (in a case of being less than 35 g) or when the gripped weight is too large (in a case of exceeding 75 g), the movement control unit 315 performs control to set the gripper claws 111 of the gripper 11 in the open state. In this case, the gripped food 21-1 falls and returns into the container 20 (step S608).

Subsequently, the target value decision unit 313 re-decides the first target value (step S609). The first target value may be re-decided to be the same as the set value in the previous time, or a value different from the set value in the previous time may be re-decided to be the first target value. For example, when the weight measurement value is large with respect to the first target value in the previous time, the first target value may be decided to be a smaller value than the previous time. In addition, when the weight measurement value is smaller than the first target value in the previous time, the first target value may be decided to be a larger value than the previous time.

Then, the processing returns to the step S604, and the gripping processing based on the first target value that is re-decided is repeated again. In the decision of the picking position in the step S604, since the picking position among a plurality of positions is decided in the processing in the previous time, the gripping processing is performed at a picking position different from the previous time.

In the determination at the step S607, in a case that the gripped weight is too large, the error with respect to the final target value (here, for example, 75 g) may be considered. That is, in a case where, for example, an error of 3 g is allowed, when the final target value is 78 g or less, the process may proceed to the processing at the next step S610.

In a case where the acquired weight measurement value satisfies the first target value (step S607: Yes), that is, in a case of a range of 35 g to 75 g, the movement control unit 315 moves the gripper 11 to the position of the platform scale 16 (step S610).

In a case where the movement control unit 315 moves the gripper 11 to a position above the platform scale 16, the gripper claws 111 of the gripper 11 are set in the open state, and the gripped food 21-1 falls into the container 22 which is disposed on the platform scale 16 (step S611).

Subsequently, the weight acquisition unit 312 acquires the weight measurement value of the food 21-1 in the container 22 measured by the platform scale 16 (step S612). Then, the weight acquisition unit 312 determines whether or not the weight measurement value is less than the final target value (step S613).

When the weight measurement value reaches the final target value (step S613: No), the food portioning processing is completed, and the control device 30 performs control to end processing. For example, the control device 30 outputs a signal, which indicates that the portioning is completed, to the container supply machine 23 to end the processing. Then, the container supply machine 23 moves the container 22 into which the food 21-1 is portioned on the platform scale 16, to the transport machine 24, and transports the next container 22 onto the platform scale 16. Placement of the next container 22 d on the platform scale 16 is recognized, and the control device 30 again starts the processing illustrated in the flowchart of FIG. 9.

When the weight measurement value is less than the final target value (step S613: Yes), that is, when the weight measurement value of the food 21-1 in the container 22 of the platform scale 16 does not reach 75 g, which is the final target value, the target value decision unit 313 decides the second target value in the next (second) gripping operation.

The second target value is set to a value obtained by subtracting the weight measurement value (the weight measurement value obtained by the platform scale 16) acquired in the step S612 from the final target value (step S614). For example, when the weight measurement value acquired in the step S612 is 65 g, the second target value is 10 g obtained by subtracting 65 g from 75 g of the final target value. Then, the processing returns to the step S602 to perform the second gripping operation.

The processes at the steps S602 to S614 are repeated until the weight measurement value reaches the final target value at the step S613. That is, the third and subsequent gripping operations may be performed after the second gripping operation.

As described above, in the present embodiment, the target value having a relatively large weight in the first gripping operation is decided, and the gripping operation by the gripper 11 is performed. When a large weight is gripped, the error of the actual gripped weight with respect to the target value increases. However, in the second and subsequent gripping operations, since the target value is reduced as compared with the first time, the error of the actual gripped weight with respect to the target value is reduced. Therefore, the food 21 can be portioned with high accuracy of the final target value by performing the second or third (or a frequency equal to or greater than that) operation. For example, although an amount of error allowed by law, industry practice, or the final target value is small, proper portioning can nonetheless be realized.

### Modification Examples

The embodiment described above can be modified in various ways. Examples of the modification thereof will be illustrated below. The embodiment described above and a modification example described below may be appropriately combined.

(1) In the embodiment described above, the gripper 11 is in a hemispherical shape in the closed state where the food 21 is gripped by the plurality of gripper claws 111, and as a result, the smaller the amount of the food 21 to be gripped, the smaller the error can be of the gripped weight with respect to the set target value. However, the configuration of the distal end part of the gripper 11 is not limited thereto.

For example, in a case of a configuration having a spherical shape in the closed state, the number and the shape of the gripper claws are not limited to the examples described above. In addition to the spherical shape, for example, a conical shape (a cone or a pyramid) may be used. In short, it is preferable that the distal end of the shape gradually tapers with respect to the Z-axis direction (a direction in which insertion is made into the food; in a depth direction).

In addition, depending on the properties of the target object to be portioned, in the state of being gripped, a structure in which a closed space such as a sphere or a cone is not formed (in other words, the distal ends of the respective claws are not in contact with each other) may be used.

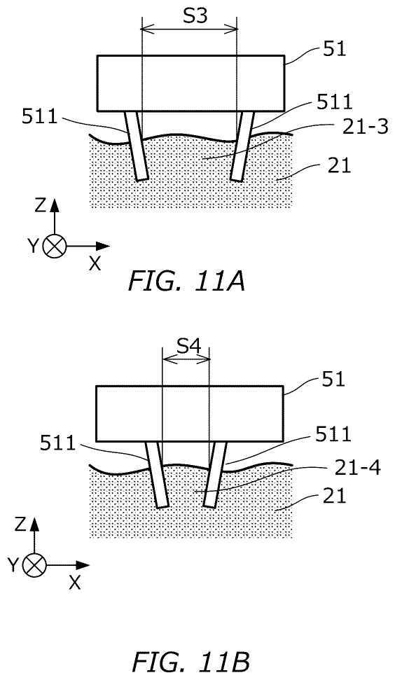

FIG. 11 is a diagram describing a schematic shape of a gripper claw 511 of a gripper 51 according to the modification example and the gripping of the food 21. FIG. 11A is a diagram illustrating a case where a relatively large amount of food 21-3 is gripped, and FIG. 11B is a diagram illustrating a case where a relatively small amount of food 21-4 is gripped.

As illustrated in the figure, a plurality of (two in the example of the figure) flat plate-shaped gripper claws 511, which are gripping members, are provided at the distal end part of the gripper 51 to face each other such that they are in a state of being respectively inclined inward (center side). The gripper 51 is dropped, the gripper claws 511 are inserted into the food 21, and the two gripper claws 511 are moved respectively inward (the distance between the gripper claws 511 is shortened), so that the food 21-3 or the food 21-4 between the two gripper claws 511 is gripped.

As illustrated in FIG. 11, the distance between the two gripper claws 511 can be changed by the gripper 51. The distance between the two gripper claws 511 in FIG. 11A is longer than the distance between the two gripper claws 511 in FIG. 11B. In FIGS. 11A and 11B, the length of the gripper claws 511 in the Z-axis direction (up-down direction) does not change.

As illustrated in FIG. 11A, by increasing the distance between the two gripper claws 511, an area S3, which is the range in which the food 21 can be gripped, can be increased. In addition, as illustrated in FIG. 11B, by shortening the distance between the two gripper claws 511, an area S4, which is the range in which the food 21 can be gripped, can be reduced.

As in FIGS. 5A and 5B in the embodiment described above, in a case where the range of the relatively large area S3 of the surface of the food 21 is gripped, as illustrated in FIG. 11A, the weight of the gripped food 21-3 is subject to an increased weight error with respect to the target value, as compared with a case where the range of the relatively small area S4 is gripped as illustrated in FIG. 11B.

Therefore, in the first gripping operation in which the target value is relatively large, a relatively large amount of the food 21-3, as illustrated in FIG. 11A, is gripped to acquire a weight close to the final target value, and in the second and subsequent gripping operations in which the target value is relatively small, a relatively small amount of the food 21-4 is gripped. In this manner, the error of the gripped weight with respect to the target value for the second and subsequent times can be reduced, and the food 21 having the weight of the final target value can be acquired by the second or third gripping.

(2) In the embodiment described above, in the container 20 into which the food 21 is put, the side surfaces that act as walls extending from the four sides of the bottom surface, but a configuration in which the side surfaces that act as walls need not be adopted.

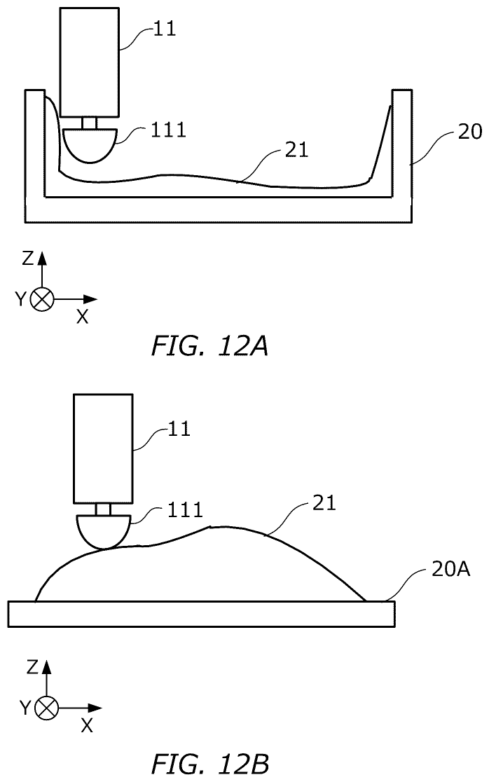

FIG. 12 is a diagram describing a container 20A according to the modification example. FIG. 12A is a diagram illustrating a gripping operation of the food 21 by using the container 20 according to the embodiment described above. FIG. 12B is a diagram illustrating a gripping operation of the food 21 by using the container 20A according to the modification example.

In FIG. 12A, the container 20 is configured to have a bottom surface 201 and a side surface 202. In a case where the gripper 11 performs the gripping operation of the food 21 in the container 20, as described above with reference to FIGS. 8B and 8C, the gripper claws 111 are moved in a horizontal direction in a state where the food 21 is partially gripped by the claws 111, to press the food 21 in the vicinity, and an operation is performed in which the food 21 adhering to the outer surface of the gripper claws 111 is rubbed against the food 21 in the vicinity.

In a case where such a gripping operation is repeated in the container 20, the gripping operation is performed at a position close to the side surface 202 on the outer peripheral side of the container 20. In this case, as illustrated in FIG. 12A, the food 21 at a position close to the side surface 202 is pressed against the side surface 202, and the food 21 gradually adheres to the side surface 202.

It is difficult to grip the food 21 adhering to the side surface 202 with the gripper claws 111. In addition, in a case where the gripping operation is performed by the gripper 11 at a position close to the side surface 202, the food 21 adhering to the side surface 202 may come into contact with an outer peripheral part of the gripper 11 above the gripper claws 111 and adhere to the gripper 11. Consequently, it is difficult to sweep off the food 21 adhering to a part other than the gripper claws 111 of the gripper 11, and as a result accuracy of the measurement by the weight meter 14 may be adversely affected.

In the container 20A of FIG. 12B, the side surface 202 is not provided, and the food 21 is placed on the bottom surface 201. In such a configuration, in a case where the gripping operation of the food 21 by the gripper 11 is repeated in the container 21A, the food 21 spreads to the outer peripheral side of the container 20A. However, since there is no side surface as illustrated in FIG. 12A, the food 21 does not adhere to a part other than the gripper claws 111 of the gripper 11.

In addition, by sequentially performing the gripping operation by the gripper 11 of the food 21 on the outer peripheral side of the container 20A, it is possible to prevent the food 21 from being pushed outward to the outside of the side surface 202 of the container 20A and thus bring the food 21 to the inside.

(3) In the embodiment described above, the target value of the weight of the food to be gripped in the gripping operation by the gripper 11 is optionally set by the user, but in the control device 30, the target value may be set in consideration of the physical properties (viscosity or the like) or the type of the food, the frequency of the gripping, or time constraint, or the error allowed in the final target weight, or the like.

In addition, in the embodiment described above, although it is assumed that the gripping operation is performed a plurality of times, the upper limit value of the frequency of the gripping operations (the frequency of the portioning operation) may be preset, and the target value of each time may be decided each time based on the upper limit value.

(4) In the embodiment described above, although the picking position is decided by calculating the volume of the food corresponding to the weight of the target value and deciding a position at which the food having the calculated volume can be gripped based on the image data and the height data of the food from the imaging device 15, in the control device 30, a learning model may be generated in advance, and the picking position may be decided using the learning model.

For example, using the food portioning device 1 according to the embodiment described above, for each type of food, at a plurality of picking positions, the food is gripped by the gripper 11, and the weight of the gripped food is measured by the weight meter 14 or the platform scale 16. A learning model that learns the measurement data and the image data at each picking position imaged by the imaging device 15 is generated by the control device 30.

In the actual food portioning processing, the target value decision unit 313 of the control device 30 decides the picking position (the picking position of the first gripping operation and the picking positions of the second and subsequent gripping operations) from the target value of the weight to be gripped and the image data of the food from the imaging device 15 by using the learning model corresponding to the type of the target food.

(5) In the embodiment described above, the position decision unit 314 of the control device 30 decides the picking position at which the food 21 having a volume corresponding to the weight of the target value can be gripped, based on the preset average density data of the food 21. Alternatively, the position decision unit 314 may decide the picking position depending on the density of each portion of the food 21 calculated based on the image data of the food 21 from the imaging device 15.

For example, when the food 21 is potato salad, by utilizing image data from image recognition, the density of each portion can be estimated by the distribution of the potato, the cucumber, and the carrot, which are food ingredients constituting the potato salad, that is, the proportion of each food ingredient in each portion. By estimating a volume that can be gripped at the picking position candidate by using the estimated values of the densities, the picking position can be decided. As described above, even in a case of food having an uneven density, the picking position can be appropriately decided.

(6) In the embodiment described above, the movement control of moving the gripper claws 111 of the gripper 11 in the XY plane (horizontal plane) as illustrated in FIGS. 8B and 8C during the rotation control of the gripper 11 in a state of gripping the food 21-1 is performed, but in addition to the movement control or instead of the movement control, a control of moving the gripper claws 111 downward in the gripper rotation axis L direction (the downward direction of the Z-axis; the direction toward the bottom of the container) may be performed. The movement control can be performed by the movement control unit 315 of the control device 30 driving and controlling the robot arm 12 as in the movement control shown in FIGS. 8B and 8C.

In this way, the gripper claws 111 are moved downward while the gripper 11 is rotated or while the control of moving the position of the gripper rotation axis L is performed, so that the outer surface of the gripper claws 111 can be pressed against the food 21 located below, and the food 21 adhering to the lower surface of the gripper claws 111 is rubbed against the food 21 located below and thus can be removed.

Similarly, the gripper claws 111 may be moved upward while the gripper 11 is rotated or while the control of moving the position of the gripper rotation axis L is performed. That is, at step S655 of FIG. 8, the gripper claws 111 are pulled up while the rotation operation and/or the movement operation in the XY plane is performed, so that the food adhering to the gripper claws 111 can be rubbed against or shaken off onto the food in the vicinity.

(7) In the embodiment described above, in a case where the rotation control centered on the gripper rotation axis L of the gripper 11 is performed after the food 21 is gripped, the rotation angle is optionally set, but the rotation angle may be set according to the viscosity of the food 21. For example, the rotation angle may be increased when the food 21 to be gripped has a higher viscosity. In addition, a rotation speed may be set instead of the rotation angle. For example, the rotation speed may be decided to be increased corresponding to a case where the food 21 having a large viscosity is gripped.

In addition, regarding the movement control of the gripper rotation axis L in the horizontal direction illustrated in FIG. 8B, the movement distance or the movement speed may be set according to the viscosity of the food 21. For example, the movement distance of the gripper rotation axis L in the horizontal direction may be increased when the food 21 to be gripped has a higher viscosity. In addition, for example, the movement speed of the gripper rotation axis L in the horizontal direction may be decided to be increased corresponding to a case where the food 21 having a large viscosity is gripped.

In addition, regarding the rotation control centered on the central axis R of the gripper rotation axis L illustrated in FIG. 8C, the rotation angle or the rotation speed may be set according to the viscosity and other physical properties of the food 21. For example, the rotation angle centered on the central axis R of the gripper rotation axis L may be increased when the food 21 to be gripped has a higher viscosity. In addition, the rotation speed centered on the central axis R of the gripper rotation axis L may be increased when the food 21 having a higher viscosity is gripped. Similarly, according to the physical properties of the food 21, the movement speed of the gripper claws 111 in the Z-axis direction may be set, or the movement speed, the movement amount (distance), and the path of the gripper rotation axis L in the XY plane may be set.

(8) In the embodiment described above, the food is the target, but the present invention can be applied to an object other than the food, as long as the object can be gripped. The device according to the embodiment of the present invention is particularly suitable for processing portioning of a viscous object having an indefinite shape.

(9) In the embodiment described above, the food 21 is portioned into the container 22, but when the food ingredients of a meal for a customer in a restaurant or the like are portioned, portioning may be performed on tableware such as a dish. In this case, a tableware supply machine may be installed instead of the container supply machine 23.

In short, in a portioning method according to the present invention includes, a step of deciding a first target value of a weight of an object to be portioned in one gripping operation, which is calculated based on a final target value of a portioning amount in a case of portioning a portion of the object, a step of deciding a first picking position corresponding to the first target value based on a captured image, and a step of moving a gripper to the first picking position to grip a portion of the object and execute portioning of the object. When the weight of the portioned object by one gripping operation satisfies the target value, a second target value of the weight of the object to be portioned by a next gripping operation is decided, a second picking position corresponding to the second target value is decided, and the gripper is moved to the second picking position to grip and execute the portioning of the object, and when the weight of the object portioned by the one gripping operation by the gripper does not satisfy the first target value, the first target value is re-decided to execute gripping of the object at the re-decided first target value.

### DESCRIPTION OF REFERENCE NUMERALS

1 food portioning device
11 gripper
12 robot arm
13 rotation mechanism
14 weight meter
15 imaging device
16 platform scale
20 container
21 food
22 container
23 container supply machine
24 transport machine
30 control device
51 gripper
111 gripper claws
112 connecting part
113 base body
116 internal wiping member
117 sweeping member
201 bottom surface plate
202 side surface plate
301 processor
302 memory
303 input/output interface
311 image acquisition unit
312 weight acquisition unit
313 target value decision unit
314 position decision unit
315 movement control unit
316 rotation control unit
511 gripper claw
1121 connecting gear
1122 rotatable shaft
1123 support member
1131 motor

1. A food portioning device comprising:
a gripper configured to grip a portion of food having an indefinite shape and provided in a container;
a moving mechanism configured to move the gripper;
a weighing unit configured to measure a weight of the food held by the gripper;
an imaging unit configured to image a surface shape of the food;
a decision unit configured to decide a first target value of a weight of the food to be portioned by one gripping operation, which is calculated based on a final target value to be portioned, and to decide a first picking position corresponding to the first target value based on an image captured by the imaging unit; and
a control unit configured to execute portioning of the food by moving the gripper to the first picking position by the moving mechanism,
wherein, when a weight of the food portioned by the one gripping operation by the gripper satisfies the first target value, the decision unit decides a second target value of a weight of the food to be portioned by a next one gripping operation and decides a second picking position corresponding to the second target value, and the control unit executes portioning of the food by moving the gripper to the second picking position, and
when the weight of the food portioned by the one gripping operation by the gripper does not satisfy the first target value, the decision unit re-decides the first target value, and the control unit executes gripping of the food at the re-decided first target value.

2. The food portioning device according to claim 1,
wherein a distal end of the gripper is tapered toward where the food is gripped.

3. The food portioning device according to claim 1,
wherein a shape of the gripper part is changed according to the first target value and the second target value.

4. The food portioning device according to any one of claims 1 to 3,
wherein the decision unit decides, for each food, a frequency of the gripping operation to be executed and a target value of a weight of the food to be portioned in each gripping operation.

5. The food portioning device according to any one of claims 1 to 4,
wherein the decision unit generates a learning model that has learned, for each food, measurement data of a weight of the food gripped by the gripper at a picking position and image data of the picking position, and decides the first picking position and the second picking position using the learning model.

6. The food portioning device according to any one of claims 1 to 5,
wherein a density of the food is uneven, and
the decision unit decides the first picking position and the second picking position further based on a density calculated based on the image.

7. A program that causes a computer to function as:
a decision unit configured to decide a first target value of a weight of food to be portioned by one gripping operation, the first target value calculated based on a final target value of a portioning amount when portioning a portion of the food having an indefinite shape, and, based on a captured image, decide a first picking position corresponding to the first target value; and
a control unit configured to execute portioning of the food by moving to the first picking position a gripper that grips a portion of the food at the first picking position, wherein
when a weight of the food portioned by the one gripping operation by the gripper satisfies the first target value, the decision unit decides a second target value of a weight of the food to be portioned by a next one gripping operation and decides a second picking position corresponding to the second target value, and the control unit executes portioning of the food by moving the gripper to the second picking position, and
when the weight of the food portioned by the one gripping operation by the gripper does not satisfy the first target value, the decision unit re-decides the first target value, and the control unit executes gripping of the food at the re-decided first target value.
